(19) United States
(12) Patent Application Publication
(10) Pub. No.: US 2004/0256135 A1
(43) Pub. Date: Dec. 23, 2004

(54) Cable extension wire

(76) Inventor: Wei-Ho Liu, Tu-Cheng City (TW)

Correspondence Address: Ta Hsing Electric Wire & Cable Co., Ltd., P.O. Box No. 6-57, Junghe, Taipei, 235, TW

(21) Appl. No.: 10/600,370

(22) Filed: Jun. 23, 2003

(51) Int. Cl. H01B 1/00

(52) U.S. Cl. 174/71 R; 174/72 A

(57) ABSTRACT

A cable extension wire includes a socket connected by a cable wire at a rear end of a plug thereof, and an accommodating chamber disposed at an end portion of the socket. Wherein, a connecting piece is provided at an outer edge of the accommodating chamber at a tube-shaped housing of the socket, and the other end of the connecting piece is provided with a cover. The characteristics of the invention are that, one side of the cover is disposed with a protruding loop further having a circular groove at a root portion thereof. Using the aforesaid structure, the protruding loop at one side of the cover is pressed into the accommodating chamber for preventing invasions of dust and moisture into the socket.

### BACKGROUND OF THE INVENTION

(a) Field of the Invention

The invention relates to a cable extension wire, and more particularly, to a cable extension wire having a cover at side plane of a socket thereof, thereby accomplishing dust-proof and moisture-proof purposes when the socket is not in use by covering an end portion of the socket.

(b) Description of the Prior Art

Referring to FIG. 5, a prior industrial and engineering cable extension wire comprises a plug 60, and a main cable wire 70 connected with a rear end of the plug 60. The main cable wire 70 is divided into a plurality of cable wires 71, 72 and 73, and each of the cables 71, 72 and 73 is provided with a socket 80 at an end portion thereof. This prior cable wire is a one-to-many extension wire that when one end thereof is plugged to a power supply, multiple power sockets 80 are allowed to function at the other end thereof.

However, when the aforesaid cable wire is in use, not all sockets 80 of the extension wire are simultaneously used by other plugs 600. Referring to FIG. 4, an unused plug 80 is generally idly placed aside.

Such industrial cable wires are mostly utilized in factories, outdoors or wild countries, and are therefore prone to stains from dust, attachment of moisture, and even splashing of rain. As a result, insertions holes 81 within the sockets 80 are easily jammed by dust and invaded by moisture, such that copper pieces at interiors of the sockets 80 are oxidized, rusted and eroded, and further leading to poor electric conductivity and short-circuits.

Although plentiful sockets are provided using the prior multi-socket extension wire, the insertion holes of the sockets are often exposed to the exterior for that not all the sockets are in constant use Hence, the prior extension wire has drawbacks as having poor electric conductivity or other unpredictable hazards caused by adherence of dust and moisture at the socket holes.

In addition, the extension wire is inevitably dragged and pulled by passersby when in use, and the plug 60 at a remote end may be pulled off and thus cutting off electricity. However, no apparent signs of indication showing power having been cut off are observed, and it is common that a user assumes that an electric appliance connected has some sort of malfunctioning. Many checks may have to be carried out before finding loosening of the plug 60, and tremendous amount of time is frequently wasted during the process. Especially in dark rooms, checking is made even more difficult, and thus adding another drawback to the prior extension wire.

### SUMMARY OF THE INVENTION

In the view of the aforesaid shortcomings, the primary object of the invention is to provide an extension wire, which comprises at least a socket connected by a cable wire at a rear end of a plug thereof, and an accommodating chamber disposed at an end portion of the socket. The characteristics of the invention are that, a connecting piece is provided at an outer edge of the accommodating chamber at a tube-shaped housing of the socket, and the other end of the connecting piece is provided with a cover; and one side of the cover is disposed with a protruding loop further having a circular groove at a root portion thereof. Using the aforesaid structure, the protruding loop at one side of the cover is pressed into the accommodating chamber for preventing invasions of dust and moisture into the socket.

### BRIEF DESCRIPTION OF THE DRAWINGS

FIG. 1 shows a structural view according to the invention.

FIG. 2 shows a sectional view illustrating the socket according to the invention not in use.

FIG. 3 shows a sectional view illustrating the socket according to the invention being connected to another plug.

FIG. 4 shows a plug and a socket in an embodiment according to the invention.

FIG. 5 shows a conventional structural view of a prior art.

### DETAILED DESCRIPTION OF THE PREFERRED EMBODIMENTS

To better understand the contents of the invention, detailed descriptions shall be given with the accompanying drawings hereunder.

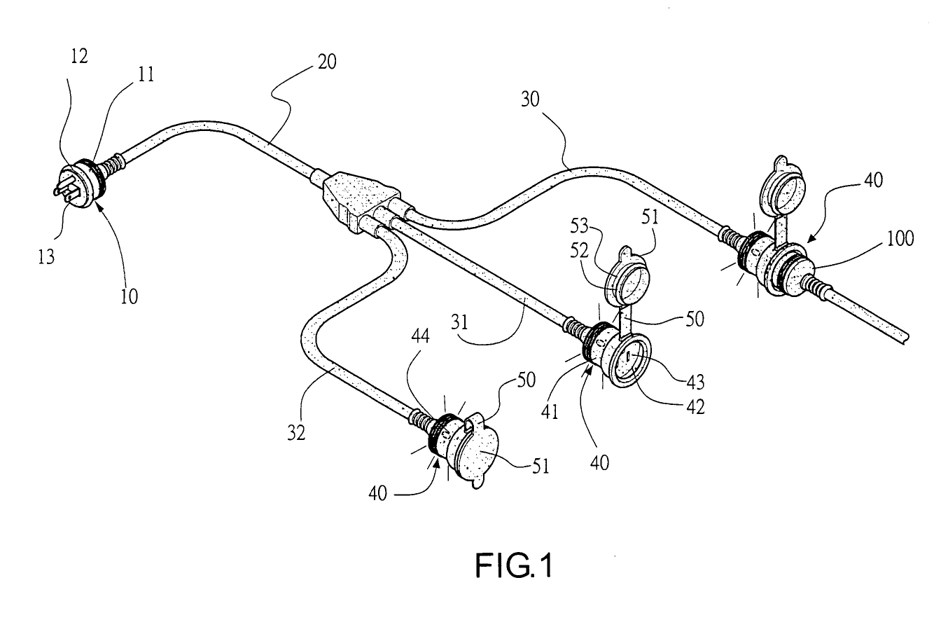

Referring to FIG. 1, the invention comprises a plug 10, and a main cable wire 20 connected with a rear end of the plug 10. The main cable wire 20 is divided into a plurality of secondary cable wires 30, 31 and 32, and an end portion of each of the secondary cable wires 30, 31 and 32 is provided with a socket 40. Wherein, the plug 10 is disposed with a tube-shaped housing 11, a circular flange 12 at an outer periphery of the tube-shaped housing 11, and an accommodating chamber 13 at an end portion thereof; and the socket 40 is similarly provided with a tube-shaped housing 41, an accommodating chamber 45 in an indented manner at an end portion thereof, and insertion holes 43 at a bottom portion thereof. The characteristics of the invention are that, a connecting piece 50 is provided at an outer edge of the accommodating chamber 45 at the tube-shaped housing 41, and the other end of the connecting piece 50 is provided with a cover 51. One side of the cover 51 is disposed with a protruding loop 52 further having a circular groove 53 at a root portion thereof.

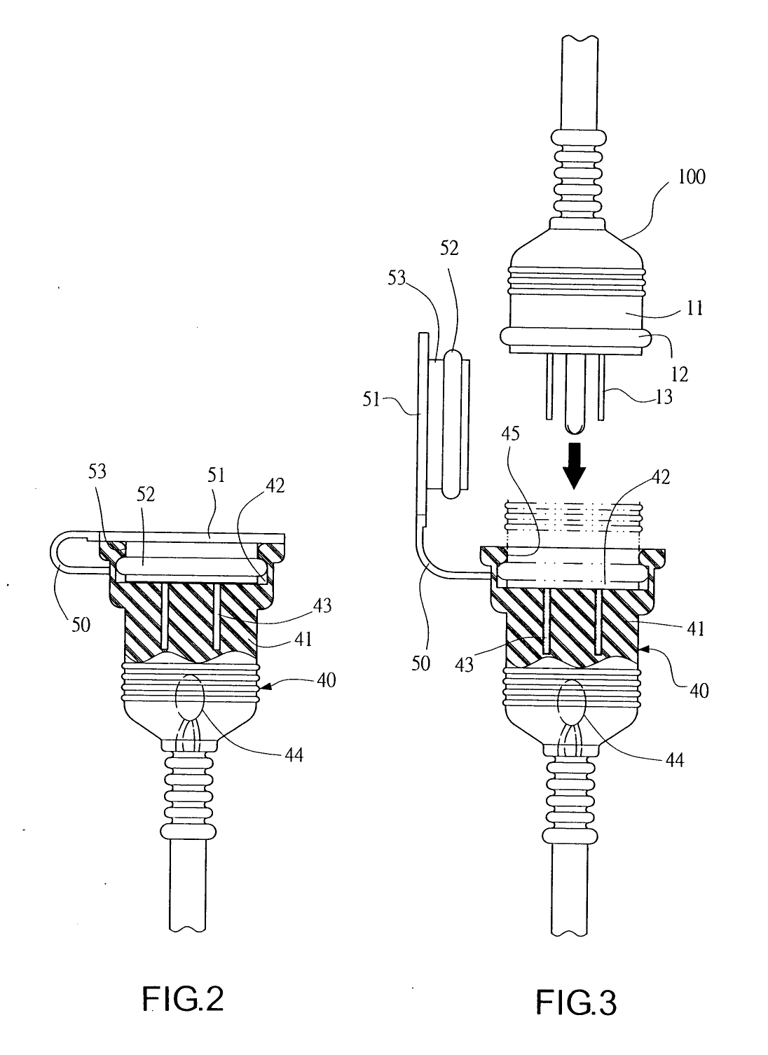

Referring to FIGS. 1 and 2, when the plug 40 is not in use, the protruding loop 52 at one side of the cover 51 is pressed into the accommodating chamber 45. In the meanwhile, the circular groove 53 at the root of the protruding loop 52 is exactly butted against an inner edge of the accommodating chamber 45, such that the accommodating chamber 45 of the socket 40 is sealed and stuffed, thereby preventing invasions of dust and moisture into the insertion holes 43. Referring to FIGS. 1 and 2, to put the socket 40 in use, the cover 51 is opened so as to insert electrodes 13 of a plug 100 into the insertion holes 43 of the socket 40. In addition, the circular flange 12 at the end portion of the tube-shaped housing 11 of the plug 100 is precisely held at the inner edge of the accommodating chamber 45, so that the plug 100 and the socket 40 are prevented from invasions of dust and moisture.

Also referring to FIGS. 1 and 2, the socket 40 according to the invention may be transparent, and further provided with a neon light 44 at an interior thereof. When the plug 10 is in good electric connection, the neon light 44 is lit. Therefore, without being obligated to inspect the interior of the socket 10 to find reasons of not having electric conductivity, a user is able to easily recognize whether valid electric conductivity is present. Especially at night or in dark working environments, the design of the neon light 44 offers conveniences for speeding up processes of other tasks.

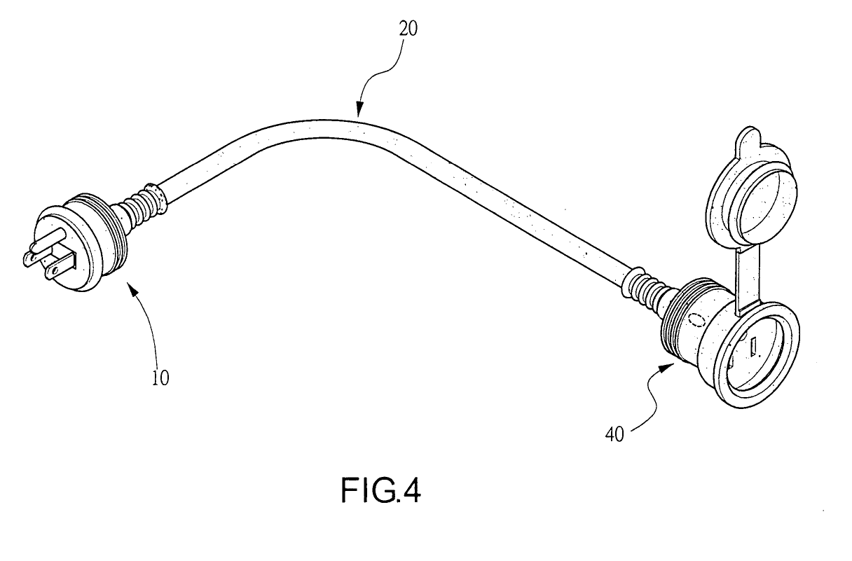

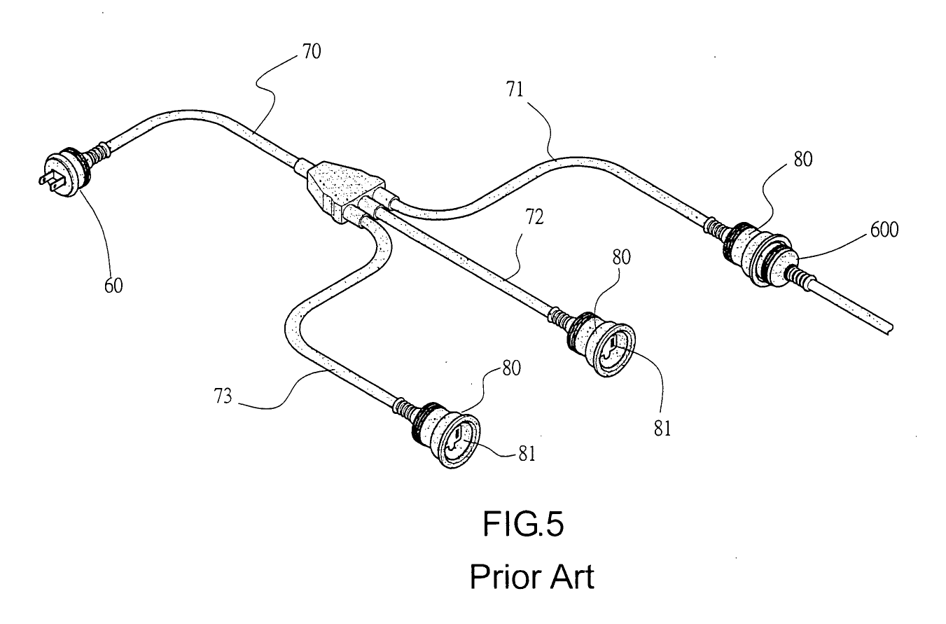

Referring to FIG. 4, the invention may also be applied as a cable extension wire having a single socket 40 connected with a single plug 10 via a main cable wire 20.

According to the invention, on one side of a tube-shaped housing of a socket is provided with a cover via a connecting piece. Insertion holes of the socket are sealed using the cover for preventing invasions of dust and moisture, thereby lengthening lifespan, providing good electric conductivity as well as keeping away from short-circuits.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A cable extension wire comprising a plug, a cable wire connected with a rear end of the plug and provided with a connected socket, wherein an accommodating chamber is disposed at an end portion of the socket and insertion holes are provided at a bottom portion of the accommodating chamber; and
the characteristic being that, a connecting piece is provided at an outer edge of the accommodating chamber at a tube-shaped housing of the socket, and the other end of the connecting piece is provided with a cover; and one side of the cover is disposed with a protruding loop further having a circular groove at a root portion thereof, thereby pressing the protruding loop at one side of the cover into the accommodating chamber for preventing invasions of dust and moisture into the socket.

2. The cable extension wire in accordance with claim 1, wherein the plug and the socket are both tube-shaped housings.

3. The cable extension wire in accordance with claim 1, wherein the cover is provided with a circular groove at a root portion thereof.

4. The cable extension wire in accordance with claim 1, wherein the socket is transparent and further has a neon light at an interior thereof, and the neon light is lit up when the plug is in good electric conductivity with a power supply.
